(19) United States
(12) Patent Application Publication
(10) Pub. No.: US 2015/0042105 A1
(43) Pub. Date: Feb. 12, 2015

(54) DOOR-LOCK DEVICE FOR A DOOR OF A HOUSEHOLD APPLIANCE

(71) Applicant: BITRON S.P.A., TORINO, TO (IT)

(72) Inventors: Fabrizio Promutico, Torino (IT); Emiliano Coccia, Torino (IT)

(21) Appl. No.: 14/375,764

(22) PCT Filed: Feb. 15, 2013
(86) PCT No.: PCT/IT2013/000050

§ 371 Date: Jul. 30, 2014

(30) Foreign Application Priority Data
Feb. 20, 2012 (IT) RM2012A000055

(51) Int. Cl. E05C 3/00

(52) U.S. Cl. CPC E05C 3/00
USPC 292/100

(57) ABSTRACT

A door-lock device for a door of a household appliance is described. The door is provided with a locking prong, the door-lock device having a mechanical unit with a locking hook provided with a cam and pivoted so as to rotate in order to assume a disengagement position from the locking prong, when the door is open, and an engagement position with said closing prong, when the door is closed, a lever, pivoted so as to rotate with respect to an rotation axis and provided with a contact surface interacting with the cam of the locking hook, the contact surface being shaped in such a way that the lever is capable of assuming a first position, in which it holds the locking hook in the disengagement position from the prong, and a second position, in which it holds the locking hook in the engagement position with the prong, and pushing means arranged to exert a force on the lever to maintain the contact surface of the lever in contact with the cam of the locking hook.

The present invention relates to a door-lock device for a door of a household appliance.

More specifically, the invention concerns a door lock device for washing machines and household appliances in general, studied and realized to reduce the door opening or closing noise.

In the following, the description will be directed to the use in a household appliance, but it is clear that the same should not be considered limited to this specific use.

As it is well known, at present there are different types of door-lock devices, for example for washing machines, capable to prevent the opening of the door until the household appliance operation cycle is not completed.

In general, such devices are of the electromechanical type and should have robustness performance sufficient to ensure the necessary effectiveness and efficiency even for the safety function for which they are intended. This implies, however, that such door-lock devices are rather noisy, due to the sudden jerks of the mechanisms within the door-lock that interact with each other. In other words, due to these mechanisms, within the door-lock, in the opening and closing operations even unpleasant noises are often emitted.

Moreover, door-lock devices according to the prior art, always due to internal interactions of the component parts, are in some way annoying to the touch or “feeling”, transmitting, in the opening and closing phases, the feeling of sudden movements to user's arm.

In view of the above, it is an object of the present invention, therefore, to propose a door-lock device for a household appliance that is not noisy in the opening and closing phases of the door, not presents to the touch jerks during normal use and at the same time has the necessary robusteness performance.

These and other results are obtained according to the invention with a particular assembly and kinematics of the door-lock device mechanical unit.

It is therefore a specific object of the present invention a door-lock device for a door of a household appliance, said door being provided with a locking prong, said door-lock device comprising a mechanical unit comprising a locking hook provided with a cam and pivoted so as to rotate in order to assume a disengagement position from said locking prong, when said door is open, and an engagement position with said closing prong, when said door is closed, a lever, pivoted so as to rotate with respect to an rotation axis and provided with a contact surface interacting with said cam of said locking hook, said contact surface being shaped in such a way that said lever is capable of assuming a first position, in which it holds said locking hook in said disengagement position from said prong, and a second position, in which it holds said locking hook in said engagement position with said prong, and pushing means arranged to exert a force on said lever to maintain said contact surface of said lever in contact with said cam of said locking hook.

Always according to the invention, said contact surface could have a first and a second concavity, said second concavity being arranged between said rotation axis and said first concavity, said pushing means could be arranged to act in an intermediate point to said first and second concavity of said contact surface of said lever, and when said lever is in said first position, said cam can be arranged on said first concavity, while, when said lever is in said second position, said cam could be arranged on said second concavity.

Still according to the invention, said mechanical unit further could comprise a slider, coupled with said lever, so as to assume a rest position, when said lever is in said first position, and an operating position, when said lever is in said second position.

Advantageously according to the invention, said door-lock device could comprises an electronic unit having electrical terminals, for connecting to the control unit of said household appliance, and a locking pin, capable of assuming: an extracted position, in which said locking pin engages with said slider, when it is in said operative position, so as to inhibit the returning to said rest position, and wherein said electronic unit allows said household appliance to activate; and a retracted position, in which said locking pin is disengaged from said slider.

Further according to the invention, said lever could comprise a lateral pin, arranged eccentrically with respect to said rotation axis, and said slider could have a housing, wherein said side pin of said lever (42) is inserted.

Advantageously according to the invention, said slider could have an opening with which said locking pin is engageable.

Always according to the invention, said slider could comprise a flap on which said opening is obtained.

Still according to the invention, said electronic unit could comprise a guide relief and said slider could have a guide slot on said flap, in which said relief guide is slidably engaged.

Further according to the invention, said pushing means could comprise a spring, arranged in compression, so as to exert a force on said lever.

Advantageously according to the invention, said door-lock device could comprise a containment casing, in that said locking hook comprises a pair of pins, pivoted to said containment casing, and in that said lever is pivoted with said containment casing.

The present invention will be now described, for illustrative but not limitative purposes, according to its preferred embodiments, with particular reference to the figures of the enclosed drawings, wherein:

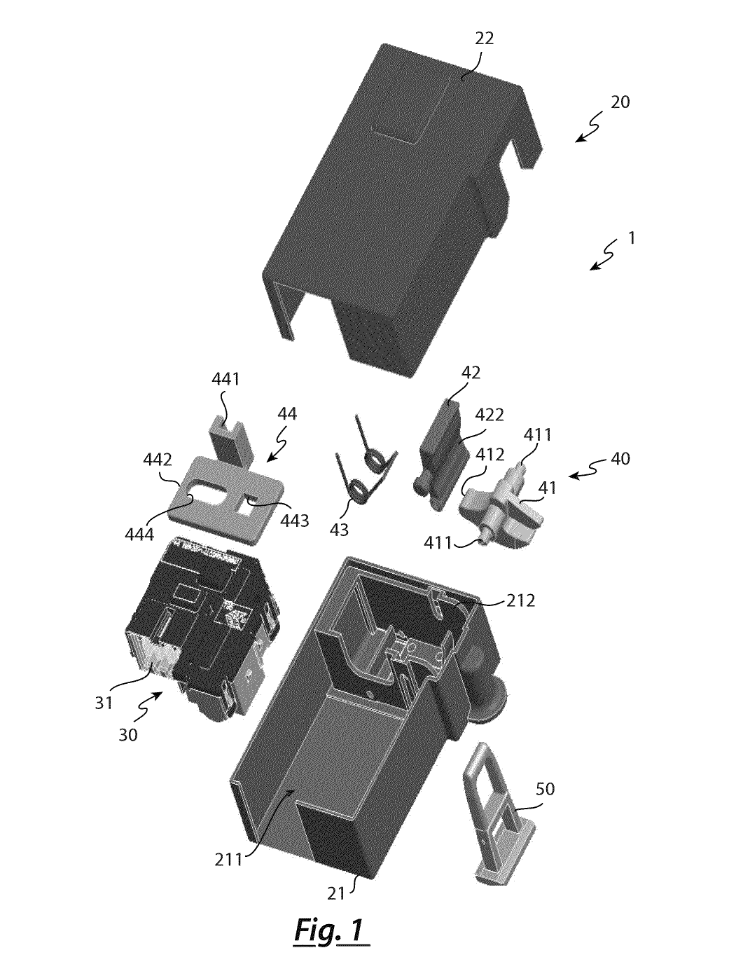

FIG. 1 shows an exploded view of the door-lock device for a household appliance door according to the present invention;

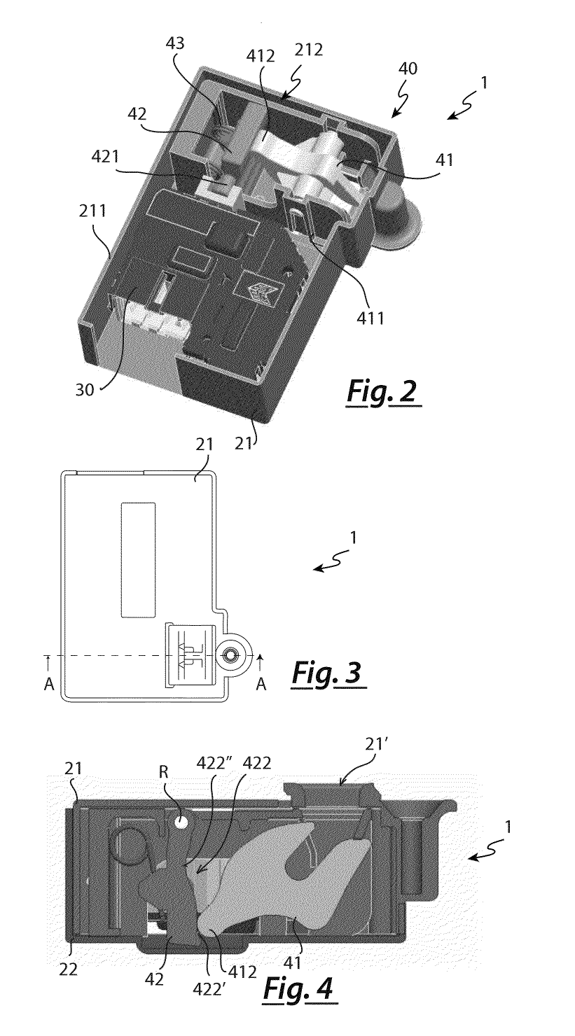

FIG. 2 shows a perspective top view of the open device according to FIG. 1;

FIG. 3 shows a bottom view of the door-lock device according to FIG. 1;

FIG. 4 shows the section along A-A line of the door-lock device according to FIG. 3;

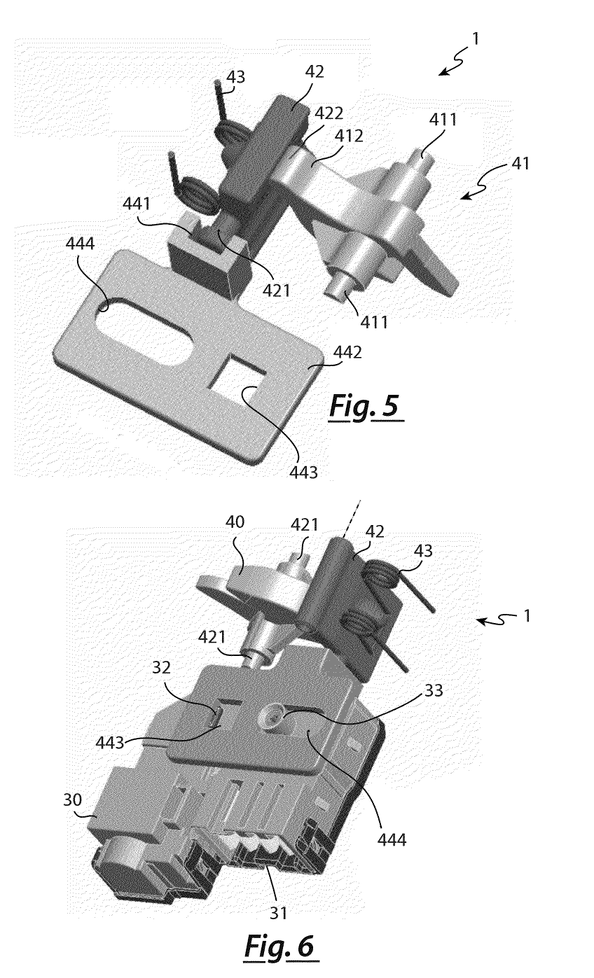

FIG. 5 shows a bottom perspective view of a blocking mechanical unit of the device according to FIG. 1;

FIG. 6 shows a bottom perspective view of the blocking mechanical unit according to FIG. 5 and of a door-lock device electronic unit according to the present invention;

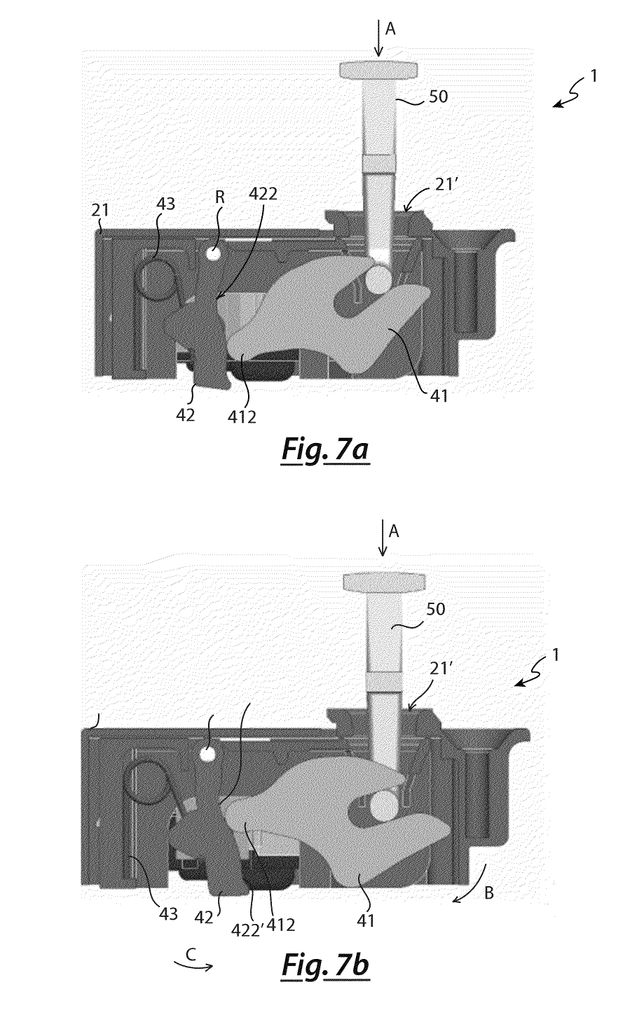

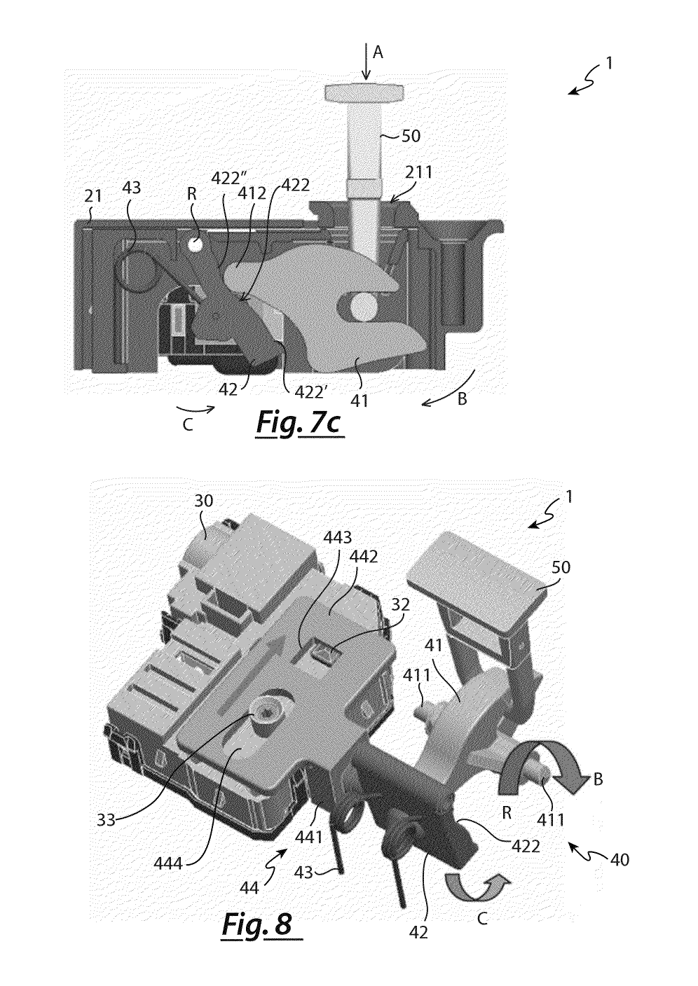

FIGS. 7a, 7b and 7c show a side sectional view of a device according to the invention during different door closing phases; and

FIG. 8 shows a perspective of the mechanical unit kinematic when the door is closed;

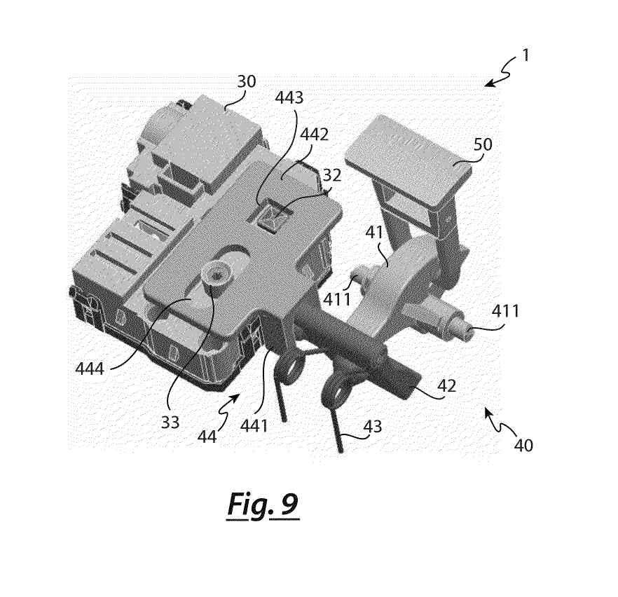

FIG. 9 shows the mechanical and electronic unit when the door is closed.

In the various figures, similar parts will be indicated by the same reference numbers.

Referring to FIGS. 1-6 the structure of a door-lock device 1 according to the present invention can be observed. Said door-lock device 1 comprises a casing 20, in which an electronic unit 30 and a blocking mechanical unit 40 of a locking prong 50, integral with a door of a household appliance (the door is not shown in the figures), are housed.

Said containment casing 20 comprises a first 21 and a second 22 element. Said first element 21 has a first opening 21′, for the introduction of the prong 50, so that it may interact with the blocking mechanical unit 40.

Furthermore, said first element 21 has even a first housing 211, in which said electronic unit 30 is housed, and a second housing 212, in which said blocking mechanical unit 40 is housed.

Said electronic unit 30 has electric terminals 31 for connecting to the household appliance control unit (not shown in the figures). Said electronic unit 30 comprises even a locking pin 32, capable of assuming a retracted position, in which said electronic unit 30 prevents said household appliance to activate, and an extracted position, in which said electronic unit 30 allows said household appliance to operate. Said electronic unit 30 has even a guide relief 33, whose function will be better explained in the following.

Said blocking mechanical unit 40 includes a locking hook 41 hinged to said first element 21 of said casing 20, by means of two lateral pins 411. Said locking hook 41 is capable to assume a disengagement position from said prong 50 and an engagement position with said prong 50. Said locking hook 41 also includes a cam 412, the operation of which will be better defined in the following.

Said blocking mechanical unit 40 also includes a lever 42, pivoted to said first element 21 of said casing 20, which is the fulcrum, so as to rotate with respect to an axis of rotation R and having a side pin 421, arranged eccentrically with respect to said axis of rotation R.

Said lever 42 has also a contact surface 422, suitably shaped, for the contact with said cam 412 of said locking hook 41. Said contact surface 422 has a first 422′ and a second 422″ concavity, said second concavity 422″ being arranged between said axis of rotation R and said first concavity 422′.

The contact between said contact surface 422 of said lever 42 and said cam 412 of said locking hook 41 is ensured by suitable pushing means, which act at an intermediate point to said first 422′ and second 422″ concavity of said contact surface 422. Said pushing means in this case comprise a spring 43. Said lever 42 is capable to assume a first position and a second position, which will be better described below.

Said blocking mechanical unit 40 also includes a slider 44, having a housing 441, in which said lateral pin 421 is inserted. Said slider 44 also has a flap 442 on which an opening 443 is formed, which is insertable into said locking pin 32 of said electronic unit 30, and a guide slot 444, which is slidably engaged in said guide relief 33. Said slider 44 is capable of assuming a rest position and an operating position, which will be better described below.

The operation of the door-lock device 1 described above is as follows.

When the door is open and, therefore, the prong 50 is disengaged from said blocking mechanical unit 40 (see FIG. 7a), the locking hook 41 is in the shown initial disengagement position from said prong 50, wherein said cam 412 is arranged on said first concavity 422′ of said contact surface 422. The action of the spring 43 between said first concavity 422′ and said rotation axis R of the lever 42, which is thus in said first position, retain said locking hook 41, in said disengaged position.

Also, in this initial disengagement position of said locking hook 41, slider 44 is in said rest position, in which is arranged such that the opening 443 is not superimposed on said locking pin 32, so that the surface of the flap 442, superimposed on said locking pin 32, holds it in said retracted position, in which, as mentioned, the household appliance cannot be activated.

Closing the door, prong 50 moves along the direction of arrow A, fitting into said first opening 21′ and intercepting said locking hook 41 (see FIGS. 7b, 7c and 8). This causes, over a certain level of exerted force, the rotation of the locking hook 41 according to the arrow B, with respect the two lateral pins 411, so that the cam 412 moves along the contact surface 422 of said lever 42, from said first concavity 422′ to said second concavity 422″. Once said cam 412 is in said second concavity 422″, the spring 43 exerts a force so as to rotate said lever 42, which thus passes from said first to said second position.

In particular, said contact surface 422, as said, is shaped in such a way that the rotation of said locking hook 41, which passes from said disengagement position to said engagement position with said prong 50, causes, as mentioned, the passage from said first position to said second position of said lever 42, which rotates, as said, with respect to the rotation axis R, according to the arrow C, of a predefined angle. The rotation of said lever 42 causes the movement of said lateral pin 421 and then the translation of said slider 44 according to the arrow D, which passes from said rest position to said operative position. In particular, once the introduction of the prong 50, the locking hook 41 is arranged, as said, in said engagement position (see FIG. 9) and the slider 44 is arranged in such a way that the opening 443 is superimposed on said locking pin 32, thus releasing it and allowing the passage of the same from said retracted position to said extracted position, which occurs when the washing machine is activated. The correct translation of said slider 44 is ensured by the interaction between said guide slot 444 and said guide relief 33.

Moreover, when said locking pin 32 is in said extracted position and inserted in said aperture 443, said slider 44 cannot slide, thus said prong 50 cannot be disengaged from said hook 41 and then said door is closed, even forcing the opening, when the household appliance is operating, as it is appropriate also for safety reasons. Furthermore, said locking hook 41 is maintained in the desired position due to the action of the lever 42 and the spring 43 on the coupling locking hook 41, for which, due to the shaping of the contact surface 422 with the cam 412 of said lever 42, said lever 42 cannot rotate, returning to the initial position, only after a sufficient force is applied on the door to open it, and after that the locking pin 32 is returned in the retracted position. This is ensured, as mentioned above, by the shaping of said contact surface 422.

When, then, the household appliance has stopped operating, locking pin 32 is retracted by means of an appropriate electronic control of the household appliance control unit to said electronic unit 30, releasing the slider 44.

Opening the door, prong 50 is disengaged from said locking hook 41 by means of a sufficient force, so as to move, overcoming the resistance exerted by the action of said lever 42 and said spring 43 on the cam 412, said locking hook 41 from said engaged position to said disengaged position. The mechanism carries out, this time in the opposite way, the same kinematic movement described above in FIGS. 7a-7c, thus also translating the slider 44 in the opposite direction of said arrow D, so that said slider 44 arranges again so that the opening 443 is not superimposed on said locking pin 32, i.e. passes from said operating position to said rest position.

The kinematic mechanism of the interaction of said cam 412, of said lever 42, said spring 43 and said slider provides a reduced noise in the closing and opening of the door, due to the fact that there is only the sliding of the cam 412 along the contact surface 422 in the passage from said first concavity 422′ to said second concavity 422″, so that said lever 42 can retain said locking hook 41 in said disengaged position from or of engagement with said prong 50, respectively when it is in said first or second position.

The present invention has been described for illustrative but not limitative purposes, according to its preferred embodiments, but it is to be understood that modifications and/or changes can be introduced by those skilled in the art without departing from the relevant scope as defined in the enclosed claims.

1. A door-lock device for a door of a household appliance, said door being provided with a locking prong, said door-lock device comprising
a mechanical unit comprising
a locking hook provided with a cam and pivoted so as to rotate in order to assume a disengagement position from said locking prong, when said door is open, and an engagement position with said closing prong, when said door is closed,
a lever, pivoted so as to rotate with respect to a rotation axis and provided with a contact surface interacting with said cam of said locking hook, said contact surface being shaped in such a way that said lever is capable of assuming a first position, in which it holds said locking hook in said disengagement position from said prong, and a second position, in which it holds said locking hook in said engagement position with said prong, and
pushing means arranged to exert a force on said lever to maintain said contact surface of said lever in contact with said cam of said locking hook.

2. The door-lock device according to claim 1, wherein said contact surface has a first and a second concavity, said second concavity being arranged between said rotation axis and said first concavity,
said pushing means are arranged to act in an intermediate point to said first and second concavity of said contact surface of said lever, and
when said lever is in said first position, said cam is arranged on said first concavity, when said lever is in said second position, said cam is arranged on said second concavity.

3. The door-lock device according to claim 1, wherein
said mechanical unit further comprises a slider, coupled with said lever, so as to assume a rest position, when said lever is in said first position, and an operating position, when said lever is in said second position.

4. The door-lock device according to claim 3, wherein it comprises an electronic unit having electrical terminals, for connecting to the control unit of said household appliance, and a locking pin, capable of assuming:
an extracted position, in which said locking pin engages with said slider, when it is in said operative position, so as to inhibit the returning to said rest position, and wherein said electronic unit allows said household appliance to activate; and
a retracted position, in which said locking pin is disengaged from said slider.

5. The door-lock device according to claim 3, wherein
said lever comprises a lateral pin, arranged eccentrically with respect to said rotation axis, and
said slider has a housing, wherein said side pin of said lever is inserted.

6. The door-lock device according to claim 3, wherein said slider has an opening with which said locking pin is engageable.

7. The door-lock device according to claim 6, wherein said slider comprises a flap on which said opening is obtained.

8. The door-lock device according to claim 7, wherein said electronic unit comprises a guide relief and said slider has a guide slot on said flap, in which said guide relief is slidably engaged.

9. The door-lock device according to claim 1, wherein said pushing means comprise a spring, arranged in compression, so as to exert a force on said lever.

10. The door-lock device according to claim 1, wherein it comprises a containment casing, said locking hook comprises a pair of pins, pivoted to said containment casing, and said lever is pivoted with said containment casing.
